(19) United States
(12) Patent Application Publication
(10) Pub. No.: US 2012/0057034 A1
(43) Pub. Date: Mar. 8, 2012

(54) IMAGING SYSTEM AND PIXEL SIGNAL READOUT METHOD

(75) Inventor: Hiroyuki TANAKA, Tokyo (JP)

(73) Assignee: HOYA CORPORATION, Tokyo (JP)

(21) Appl. No.: 13/226,719

(22) Filed: Sep. 7, 2011

(30) Foreign Application Priority Data
Sep. 8, 2010 (JP) 2010-200994

(51) Int. Cl. H04N 5/225

(52) U.S. Cl. 348/208.1; 348/E05.024

(57) ABSTRACT

An imaging system is provided that includes an area determiner and readout processor. The area determiner defines an area used in an auto focus operation within an effective pixel area of an image sensor. The readout processor reads out only pixel signals within the defined area. The size of the area is determined according to at least one of a focal length or a magnitude of camera shake.

### BACKGROUND OF THE INVENTION

1. Field of the Invention

The present invention relates to a device for reading out image signals from an image sensor and a method thereof.

2. Description of the Related Art

A contrast-detect autofocus (AF) function has been employed by various types of digital cameras where, in general, a focusing image is temporarily displayed on a monitor of the camera for a photographer to check whether or not the image is adequately in focus. However, the size of the monitor provided on the camera is usually not sufficient for a photographer to verify the quality or conditions of the focusing image when the entire image is represented on the display. In order to overcome such problems, a camera disclosed in KOKAI 2004-242010 enlarges an area with the highest degree of focusing and further indicates a subarea within the enlarged image having the highest focusing degree by framing the subarea.

### SUMMARY OF THE INVENTION

Although a high-speed autofocus operation is preferable, the conventional contrast-detect autofocus technology is at a disadvantage when carrying out high-speed focusing because it must read out all signals within an actual pixel area (an area within an effective pixel area in which the quality of an image is guaranteed).

Accordingly, one aspect of the present invention is to accelerate the contrast-detect autofocus operation while enabling an indication of a focus-verification image with high visibility.

According to the present invention, an imaging system is provided that includes an area determiner and readout processor.

The area determiner defines an area used in an auto focus operation within an effective pixel area of an image sensor. The readout processor reads out only pixel signals within the defined area. The size of the area is determined by the area determiner according to at least one of a focal length or a magnitude of camera shake.

Further, according to another aspect of the present invention, a pixel signal readout method is provided that includes defining an area used in an auto focus operation within an effective pixel area of an image sensor, reading out only pixel signals from within the defined area, and determining the size of the area according to at least one of a focal length and a magnitude of camera shake.

### BRIEF DESCRIPTION OF THE DRAWINGS

The objects and advantages of the present invention will be better understood from the following description, with reference to the accompanying drawings in which:

FIG. 1 is a block diagram schematically illustrating the general structure of a digital camera of an embodiment of the present invention;

FIG. 2 schematically illustrates the relationship between an actual pixel area (an effective pixel area) and a focus point when an image is shot through a wide-angle lens;

FIG. 3 illustrates an example of a CAF area defined in the situation of FIG. 2;

FIG. 4 illustrates the relationship between an object shot through a telephoto lens and the CAF area defined in FIG. 2;

FIG. 5 illustrates an example of the CAF area defined for the telephoto shot of FIG. 4;

FIG. 6 is a flowchart of the auto focus operation to which the pixel signal readout method of the present embodiment is applied;

FIG. 7 is a graph showing the relationship between a focal length and a frame rate;

FIG. 8 is a graph showing the relationship between a magnitude of camera shake and the frame rate; and

FIG. 9 is a graph showing the relationship between the focal length, the magnitude of camera shake and the frame rate.

### DESCRIPTION OF THE PREFERRED EMBODIMENTS

The present invention is described below with reference to the embodiments shown in the drawings.

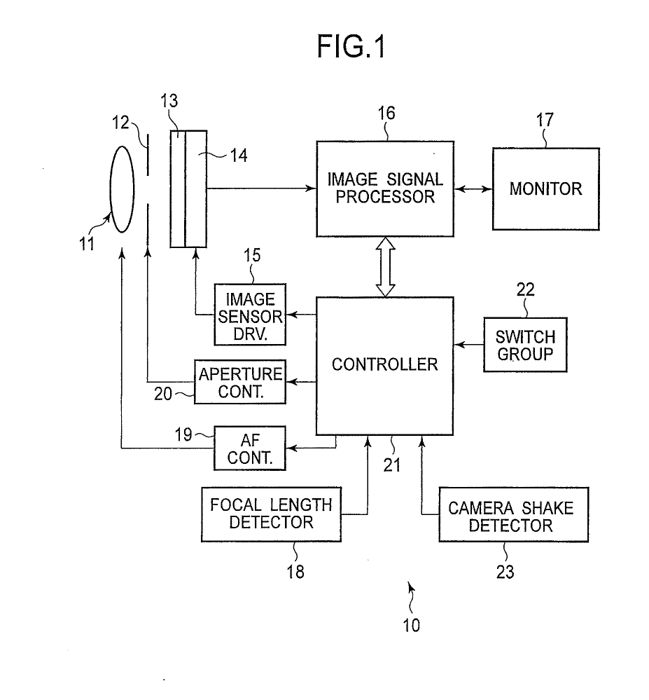

FIG. 1 is a block diagram schematically illustrating the general structure of a digital camera to which an autofocus operation of an embodiment of the present invention is applied.

The digital camera 10, for example, is a digital single-lens reflex camera. Light made incident to a lens system 11 forms an image on an imaging surface of an image sensor 14, for example, through an aperture 12 and a color filter array 13. The image sensor 14 may be controlled by drive signals from an image sensor driver 15. Image signals obtained by the image sensor 14 may be fed to an image signal processor 16 to be subjected to various types of image signal processing that are well known in the art, and in turn, the image may be displayed on a monitor 17.

An AF controller 19 may control the positions of the lenses in the lens system 11 to carry out the autofocus operation. Further, an aperture controller 20 may control the size of the aperture 12. Note that the image sensor driver 15, the AF controller 19 and the aperture controller 20 are controlled by instructions from a controller 21, and the controller 21 may perform various types of processes, including the autofocus operation (detailed later), based on the manipulation of switches in a switch group 22. The switch group 22 may include a release switch, AF button, dial switches, a touch panel, etc.

The digital camera 10 of the present embodiment is further equipped with a focal length detector 18 for detecting the focal length of the lens system 11, and a camera shake detector 23 for detecting the amount of camera shake by detecting movements of the camera body. Signals from the focal length detector 18 and the camera shake detector 23 are input to the controller 21.

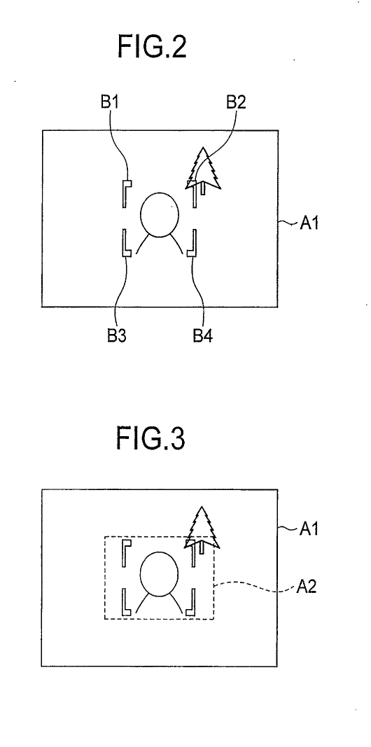

With references to FIGS. 2 to 5, an outline of a pixel signal readout operation for a contrast-detect autofocus (CAF) operation is explained.

An area A1 of FIG. 2 corresponds to an actual pixel area (or an effective pixel area) of the image sensor 14. An area of which its four corners are designated by four brackets B1-B4 indicates a focus point. Namely, the CAF operation is carried out with reference to the contrast between images centered on this area, i.e., the focus point.

Further, in the present embodiment only pixel signals from a partial image area of the actual pixel area (or the effective pixel area) A1, which will be referred to as a CAF area, are read out from the image sensor 14 at a high-speed frame rate when a high-speed CAF operation is carried out. An in-focus image of the CAF area may be magnified and temporally displayed on the monitor 17.

In FIG. 3, a CAF area A2 where pixel signals are read out for the CAF operation is shown. Namely, in the present embodiment only pixel signals within the predetermined area A2, including the area with its four corners designated by the brackets B1-B4 at its center, are read out from the image sensor 14 at a high-speed frame rate as the CAF operation is carried out in cooperation with the AF controller 19. Note that FIGS. 2 and 3 represent conditions where an image is captured with either a wide-angle prime lens or a zoom lens set at a wide-angle, i.e., with a short focal length.

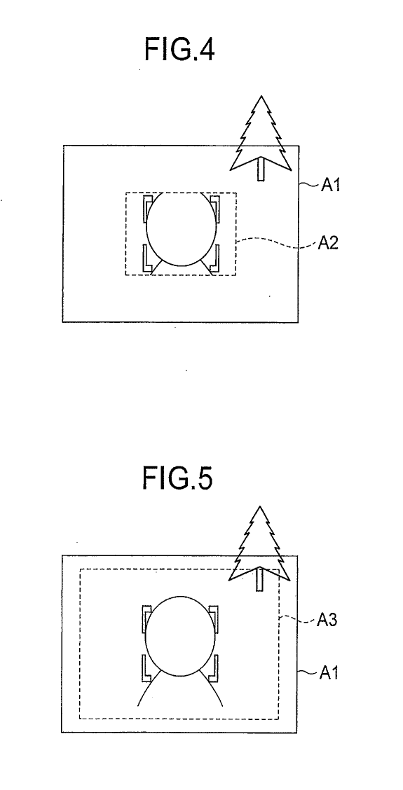

On the other hand, FIG. 4 represents a condition where an image is captured with either a telephoto prime lens or a zoom lens set at telephoto, i.e., with along focal length. If the CAF area is determined to be the size equal to the area A2 of FIG. 3 and displayed on the monitor 17 at the same magnification, an effect of the camera shake will be amplified in proportion to the reduced view-angle, and thus, verification of the focusing image becomes difficult.

Namely, when substantial frame variation exists, such as when the focal length is long (in a telephoto condition) or when an effect caused by camera shake is substantial, a small CAF area makes focusing verification difficult. In particular, this problem is prominent when shooting is performed under a telephoto condition, which exaggerates the effect caused by camera shake.

Accordingly, in the present embodiment, the frame rate is controlled with reference to the value of the focal length and/or the magnitude of the camera shake in order to accommodate the size of the CAF area, and in turn to facilitate focusing verification. FIG. 5 illustrates a situation where an area A3, which is larger than the area A2, is defined as the CAF area in accordance with the focal length while an image is captured with the same view-angle, i.e., the same focal length, as the situation illustrated in FIG. 4. Namely, the longer the selected focal length or the larger the detected camera shake, the larger the CAF area and the slower the frame rate are set.

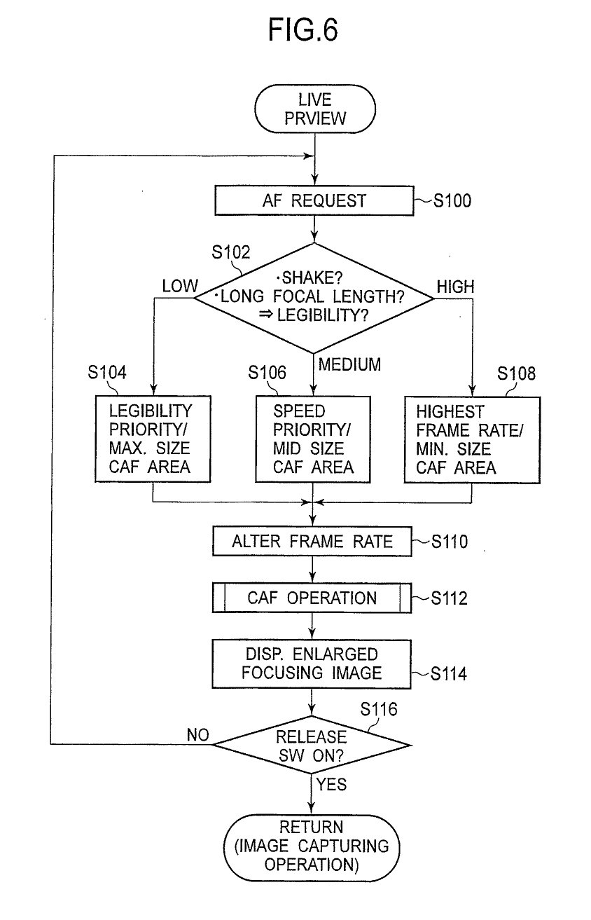

Next, with reference to the flowchart of FIG. 6, the high-speed CAF operation of the present embodiment, which is carried out mainly by the controller 21, will be explained.

The operations indicated in FIG. 6 are carried out when a through image is displayed on the monitor 17. When an AF (CAF) request is detected at Step S100, the high-speed CAF operation of the present embodiment is initiated. For example, whether an AF request has been made under continuous AF mode is determined in Step S100. Note that in the present embodiment, a situation in which the high-speed CAF operation is performed under a continuous AF mode with a fixed focus point is explained; however, the invention may also be applied to a situation with either auto focus using automatic tracking or under another mode other than the continuous AF mode.

In Step S102, the legibility of a focusing image is calculated from the focal length detected by the focal length detector 18 (see FIG. 1) and the magnitude of the camera shake detected by the camera shake detector 23. Note that the legibility may be determined with reference to a table with the focal length and the magnitude of the camera shake as two independent parameters or headers, and involve relating three distinct frame rates, which correspond to three different sizes of the CAF area, to each of the header pairs.

When it is determined that the focal length is long and the magnitude of the camera shake is large (longer and larger than predetermined values), such that the legibility of the focusing image is determined to be relatively low, i.e., the verification of the focusing image is determined to be difficult, a relatively low frame rate (a relatively large CAF area) is selected in Step S104, accordingly. When it is determined that the focal length is medium or the focal length is long but the magnitude of the camera shake is large (longer or larger than predetermined values), such that the legibility of the focusing image is of medium grade, a medium frame rate or the CAF area of a medium size is selected in Step S106. Further, when it is determined that the focal length is short and/or the magnitude of the camera shake is small (shorter and/or smaller than predetermined values), such that the legibility of the focusing image is determined to be relatively high, i.e., the verification of the focusing image is determined to be easy, a relatively high frame rate (a relatively small CAF area) is selected in Step S108.

In Step S110, the frame rate of the image sensor 14 is altered to a value selected in one of Steps S104-108. In Step S112, only the pixel signals from the CAF area are read out when the CAF operation is carried out at the frame rate selected in Step S110. Namely, a CAF operation, well known in the art, is carried out in cooperation with the AF controller 19 by comparing the contrast between images captured successively within the CAF area (see FIG. 1). At the same time, the images read out from the CAF area may in turn be magnified and displayed on the display 17.

When the CAF operation of Step S112 is completed, a focusing image within the CAF area is enlarged and displayed on the monitor 17 (see FIG. 1) in Step S114. Note that although the size of the CAF area may differ conditionally, the image within the CAF area may be enlarged to match the same size of the display 17.

In Step S116, whether the release switch has been turned on is then determined. When the release switch is turned on, this CAF operation is terminated and the normal image capturing operation commences. On the other hand, when the release switch has not been turned on, the process returns to Step S100 and stands by until an AF request is detected.

Note that when a predetermined time has elapsed after an enlarged focusing image is displayed on the monitor 17, the process may be modified to return to a normal through-the-lens image display (full view-angle). The operation would be repeated from Step S102 when considerable variation caused by either panning or a motion of a subject is detected from the image, i.e., events prompting an AF operation request in Step S100. As for detecting the variation of the image, an algorithm such as face detection or pattern recognition may be applied. Further, the operations in Steps S100-S116, for example, may be repeated if the release switch is half depressed or an exclusive CAF button is depressed. As a result, a user can easily realize when the AF operation is being carried out and verify a focusing image. Further, photocomposition balancing is facilitated in the normal image capturing operation because a through-the-lens image is displayed except for when the magnified image is shown.

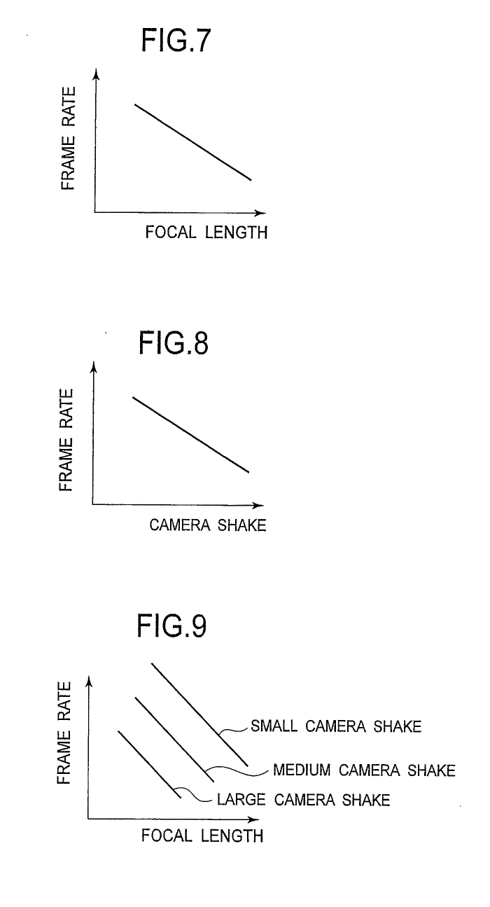

Note that in the present embodiment, the legibility is classified into three levels and three individual frame rates or three different sizes of the CAF area are assigned to each level correspondingly. However, the legibility may also be classified into more detailed levels, which are assigned to individual frame rates or area sizes. Further, the legibility may be evaluated continuously using a function. In FIGS. 7-9, typical correspondence between a focal length, a scale of the camera shake and a frame rate are graphed as examples.

FIG. 7 shows the relationship between the focal length and the frame rate. As shown in FIG. 7, the frame rate decreases as the focal length increases. FIG. 8 shows the relationship between the magnitude of the camera shake and the frame rate. The frame rate decreases as the magnitude of the camera shake increases. Finally, FIG. 9 shows the variance of the legibility, which is represented by the frame rate, with respect to the focal length and the magnitude of the camera shake. As shown in FIG. 9, when the magnitude of the camera shake is constant, the frame rate decreases as the focal length increases. Further, when the focal length is constant, the frame rate decreases as the magnitude of the camera shake increases.

As described above, according to the present embodiment a high-speed contrast-detect autofocus operation is available with a focusing image always being displayed with high visibility.

Although the present embodiment has been described for a single-lens reflex camera, the present invention is not restricted to a digital camera and may also be applied to a number of other devices, including a cell phone and the like, which is provided with a digital camera. Further, when a prime lens is used the focal length may be obtained from memory provided inside the lens barrel.

Although the embodiment of the present invention has been described herein with reference to the accompanying drawings, obviously many modifications and changes may be made by those skilled in this art without departing from the scope of the invention.

The present disclosure relates to subject matter contained in Japanese Patent Application No. 2010-200994 (filed on Sep. 8, 2010), which is expressly incorporated herein, by reference, in its entirety.

1. An imaging system, comprising:
an area determiner that defines an area used in an auto focus operation within an effective pixel area of an image sensor;
a readout processor that reads out only pixel signals within said defined area; and
a size of said area being determined by said area determiner according to at least one of a focal length and a magnitude of camera shake.

2. The imaging system as in claim 1, wherein the size of said area increases when one of said focal length or said magnitude of the camera shake increases.

3. The imaging system as in claim 2, wherein said readout processor reads out pixel signals at a frame rate corresponding to the size of said area.

4. The imaging system as in claim 3, wherein said area determiner defines the size of said area from said focal length and said magnitude of the camera shake.

5. The imaging system as in claim 2, wherein a focusing image within said area is enlarged and displayed on a monitor.

6. A digital camera comprising:
an area determiner that defines an area used in an auto focus operation within an effective pixel area of an image sensor;
a readout processor that reads out only pixel signals within said area; and
a size of said area being determined by said area determiner according to at least one of a focal length and a magnitude of camera shake.

7. A pixel signal readout method, comprising:
defining an area used in an auto focus operation within an effective pixel area of an image sensor;
reading out only pixel signals within said defined area; and
determining a size of said area according to at least one of a focal length and a magnitude of camera shake.
